(19) United States
(12) Patent Application Publication
(10) Pub. No.: US 2022/0358208 A1
(43) Pub. Date: Nov. 10, 2022

(54) SYSTEMS AND METHODS FOR ENABLING ACCELERATOR-BASED SECURE EXECUTION ZONES

(71) Applicant: Meta Platforms, Inc., Menlo Park, CA (US)

(72) Inventors: Narsing Krishna Vijayrao, Santa Clara, CA (US); Christian Markus Petersen, Golden, CO (US)

(21) Appl. No.: 17/313,873

(22) Filed: May 6, 2021

(51) Int. Cl. G06F 21/53; G06F 21/57; G06F 9/4401; G06F 9/445; G06F 21/60; G06F 13/20

(52) U.S. Cl. CPC G06F 21/53; G06F 21/575; G06F 9/4401; G06F 9/445; G06F 21/606; G06F 13/20; G06F 2221/033

(57) ABSTRACT

The disclosed computer-implemented method may include (1) receiving, by a first internal physical processor of an accelerator from an external processor, a request to access a result of executing a sensitive application within a secure execution zone of the accelerator having (a) a second internal physical processor and (b) physical memory accessible to the second internal physical processor but inaccessible to the first internal physical processor and the external processor, (2) executing, by the second internal physical processor within the secure execution zone, the sensitive application from the physical memory to generate the result, (3) making, by the second internal physical processor, the result accessible outside of the secure execution zone, and (4) relaying, by the first internal physical processor, the result to the external processor. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary system including an exemplary accelerator device.

FIG. 2 is a block diagram of portions of an exemplary compute express link system.

FIG. 3 is a block diagram of portions of an exemplary compute express link system.

FIG. 4 is a block diagram of an exemplary coherent memory space and corresponding exemplary address mappings.

FIG. 5 is a block diagram of an exemplary accelerator including an exemplary accelerator-based secure execution zone.

FIG. 6 is a block diagram of exemplary securing elements for enabling accelerator-based secure execution zones.

FIG. 7 is a flow diagram of an exemplary method for enabling accelerator-based secure execution zones.

FIG. 8 is a diagram of an exemplary data flow for executing a sensitive application within an accelerator-based secure execution zone and providing a result to an external requester.

FIG. 9 is a diagram of an exemplary data flow for processing data received from an external processor using a sensitive application hosted within an accelerator-based secure execution zone and providing a result to the external requester.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The demand for handling complex computational and memory intensive workloads (such as those involved in Artificial Intelligence (AI), Machine Learning (ML), analytics, and video/image processing) is expanding at an ever-increasing rate. Computational and memory intensive workloads are increasingly performed in large data centers by heterogeneous processing and memory systems that include general-purpose host processors, task-specific accelerators, and memory expanders that often pool and/or share resources. Within heterogeneous processing and memory systems, it may be highly desirable to secure and/or limit access to sensitive data such as personally identifiable information, financial records, credit card numbers, healthcare information, intellectual property, trade secrets, sensitive applications, proprietary algorithms, machine-learning models, passwords, cryptographic keys, and the like.

Recent extensions to general-purpose processors have provided hardware support for secure application execution and data management in shared-resource environments. Some conventional general-purpose processors may allow a user-mode application to create a protected region, often referred to as a “secure enclave,” within the application's address space and may provide, in some instances, hardware-enforced confidentiality and integrity protection for sensitive data and executable code against potentially malicious privileged code executing on the same general-purpose processor.

Unfortunately, conventional heterogeneous processing and memory systems may have attack surfaces that are potentially very large since they often include widely available general-purpose processors with well-known architectures and/or vulnerabilities. For at least this reason, it may be difficult for owners and/or operators of conventional heterogeneous processing and memory systems to ensure the security of sensitive data within their systems. These limitations may be especially problematic for owners and/or operators that wish to host the sensitive applications and/or data of their partners or other third parties. Accordingly, the instant disclosure identifies and addresses a need for additional and improved systems and methods for securing sensitive applications and sensitive data, especially in heterogeneous processing and memory systems.

This application is generally directed to accelerator-based secure execution zones. In some embodiments, an accelerator (e.g., a compute-express-link accelerator) may include (1) an expansion-bus interface for connecting the accelerator to one or more remote processors (e.g. remote general-purpose processors or other task-specific accelerators), (2) an expansion-bus protocol processor capable of communicating with the remote processors, and (3) one or more isolated secure execution zones. In some embodiments, each of an accelerator's isolated secure execution zones may include its own processing and storage resources that are not shared or accessible outside of the secure execution zone (i.e., not shared with the accelerator's local protocol processor or any remote processor connected to the accelerator's expansion-bus interface).

Embodiments of the present disclosure may protect the integrity and confidentiality of a sensitive application and its sensitive data while also enabling remote processors to access results of executing the sensitive application. In some embodiments, the disclosed accelerator-based secure execution zones may enable a third party's sensitive application to be executed within a partner's system in a way that prevents the partner from accessing the sensitive application and/or any of its sensitive data, which may enable partners to share intellectual property, trade secrets, proprietary algorithms, machine-learning models, and the like. In addition, the disclosed secure execution zones may provide significantly reduced attack surfaces for sensitive applications and data residing therein, especially when compared to the conventional general-purpose secure enclave technologies mentioned above. Furthermore, by locating the disclosed secure execution zones within accelerators that are separated from the potentially vulnerable general-purpose processors that access them, embodiments of the present disclosure may significantly increase the surface area and/or the number of intermediate systems that must be attacked and successfully compromised before the disclosed accelerator-based secure execution zones are ever reached.

Features from any of the embodiments described herein may be used in combination with one another in accordance with the general principles described herein. These and other embodiments, features, and advantages will be more fully understood upon reading the following detailed description in conjunction with the accompanying drawings and claims.

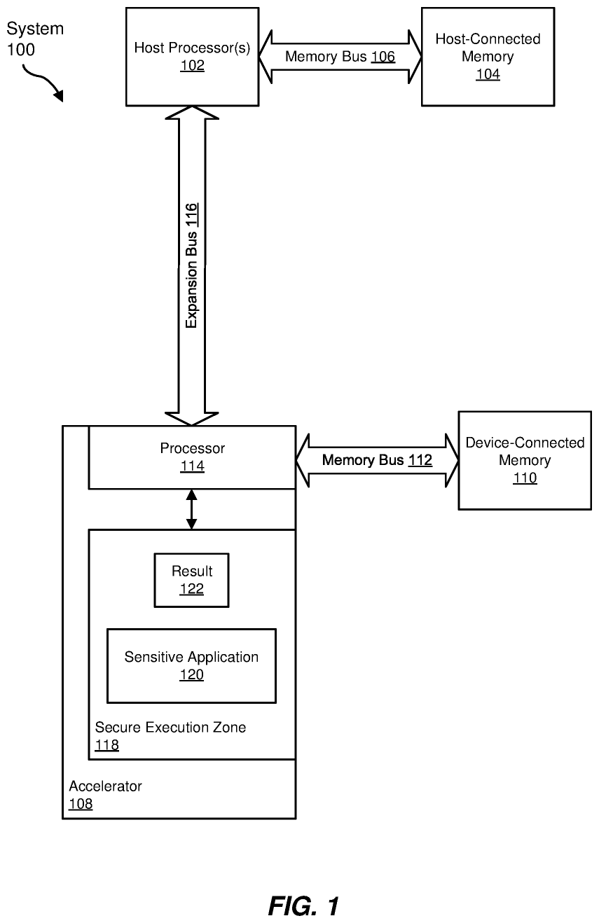

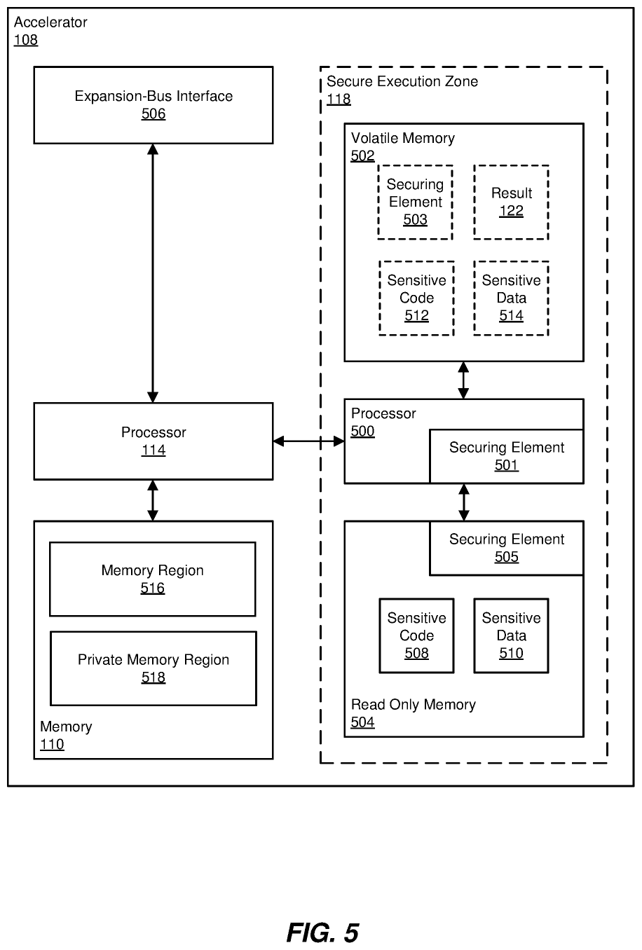

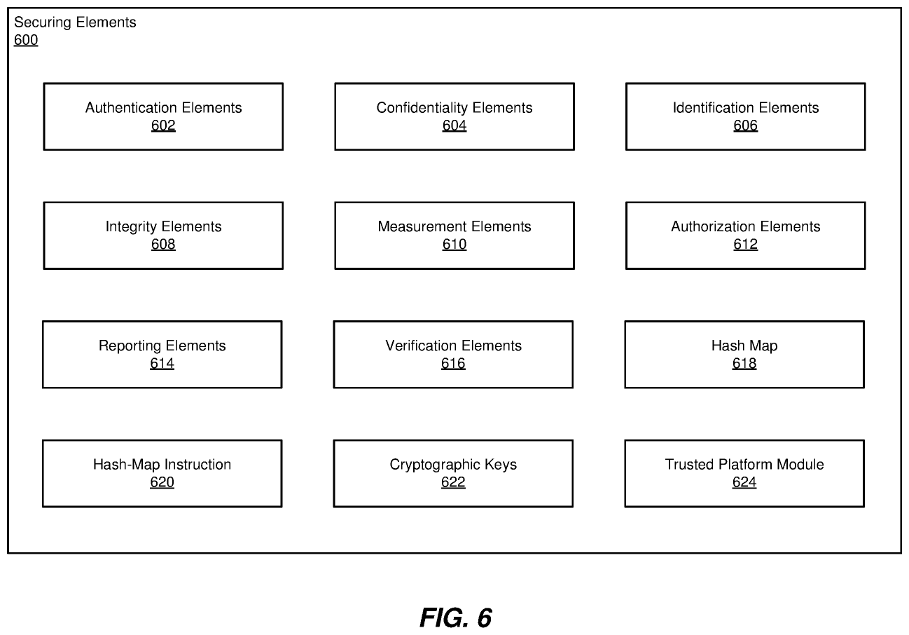

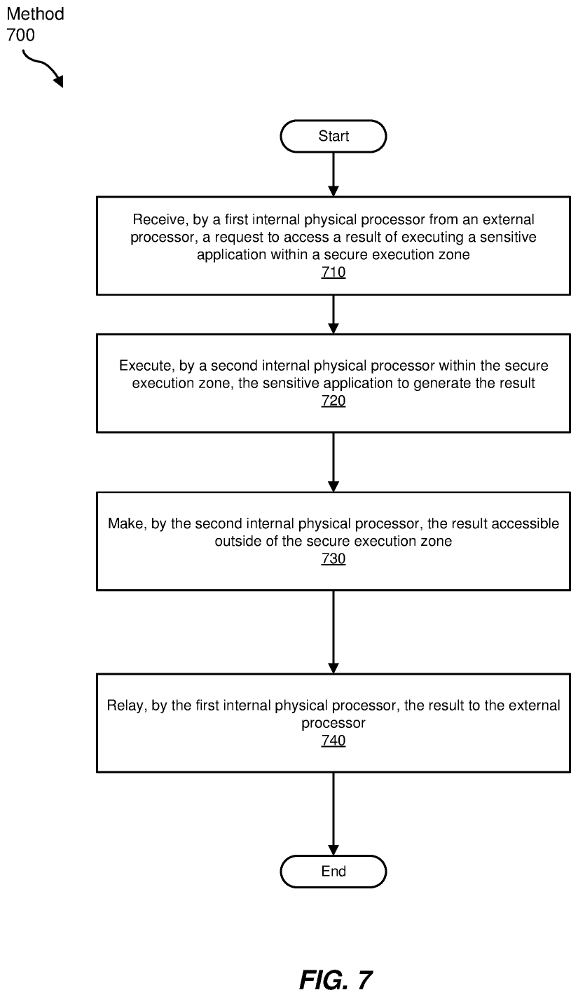

The following will provide, with reference to FIGS. 1-4, detailed descriptions of exemplary heterogeneous systems that may benefit from accelerator-based secure execution zones. With reference to FIGS. 5-6, the following will provide detailed descriptions of exemplary accelerator-based secure execution zones. The discussions corresponding to FIGS. 7-9 will provide detailed descriptions of corresponding methods and data flows.

FIG. 1 is a block diagram of an exemplary heterogeneous system 100 having an exemplary accelerator-based secure execution zone 118. As shown, system 100 may include one or more host processor(s) 102 (e.g., host central processing units (CPUs)) directly attached to a host-connected memory 104 via a memory bus 106 and an accelerator 108 (e.g., a task-specific accelerator, a storage accelerator, or memory expander) directly attached to a device-connected memory 110 via a memory bus 112. As shown, host processor(s) 102 and accelerator 108 may be interconnected through an expansion bus 116.

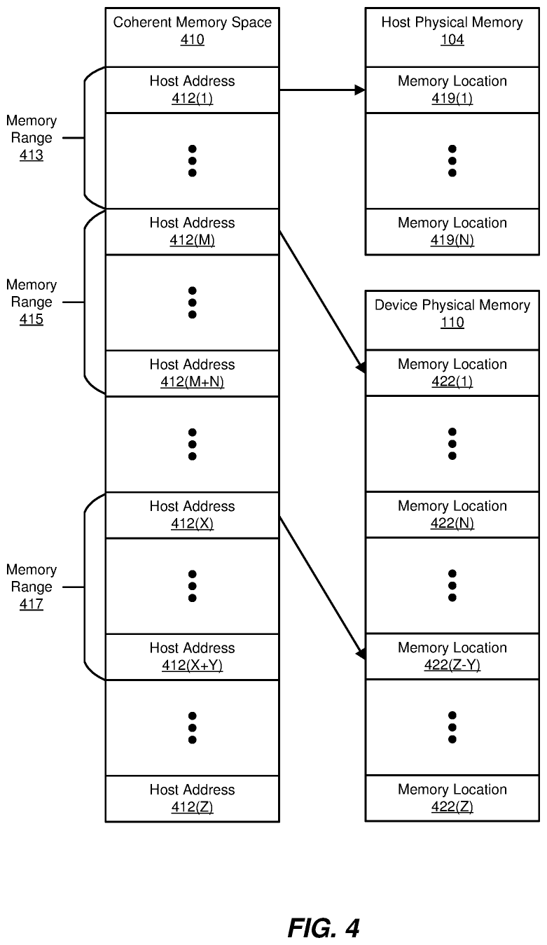

In some embodiments, host processor(s) 102 may read and write data directly to host-connected memory 104 through memory bus 106 and indirectly to device-connected memory 110 through expansion bus 116. Additionally or alternatively, accelerator 108 may read and write data directly to device-connected memory 110 through memory bus 112 and indirectly to host-connected memory 104 through expansion bus 116. In some embodiments, host processor(s) 102, accelerator 108, and/or any number of additional devices within system 100, not illustrated, may reference and/or access memory locations contained in host-connected memory 104 and device-connected memory 110 using a coherent memory space or address space (e.g., coherent memory space 410 illustrated in FIG. 4) that includes one or more host address ranges mapped to cacheable memory locations contained in host-connected memory 104 and/or one or more address ranges mapped to cacheable memory locations contained in device-connected memory 110.

As shown in FIG. 1, accelerator 108 may include a processor 114 for managing communications over expansion bus 116, performing task-specific acceleration tasks on data stored to device-connected memory 110, and/or managing any read and write operations to device-connected memory 110 and/or host-connected memory 104 that are made through expansion bus 116. In some embodiments, processor 114 may manage communications and data transmissions between host processor(s) 102 and secure execution zone 118 made via expansion bus 116. Additionally or alternatively, processor 114 may manage communications and data transmissions between secure execution zone 118 and device-connected memory 110 made via memory bus 112. Examples of processor 114 include, without limitation, microprocessors, microcontrollers, Central Processing Units (CPUs), Digital signal processors (DSPs), Field-Programmable Gate Arrays (FPGAs), Application-Specific Integrated Circuits (ASICs), portions of one or more of the same, variations or combinations of one or more of the same, or any other suitable physical processor.

As will be explained in greater detail below in connection with FIGS. 5 and 6, accelerator 108 may include one or more secure execution zones for enabling sensitive applications to expose one or more results of secretly processing one or more of (1) sensitive data stored within the secure execution zones, (2) data received over expansion bus 116, and/or (3) data stored to device-connected memory 110. For example, accelerator 108 may include a secure execution zone 118 for enabling a sensitive application 120 to provide host processor(s) 102 with a result 122 of (1) secretly processing sensitive data stored within secure execution zone 118, (2) secretly processing data received over expansion bus 116, and/or (3) secretly processing data stored to device-connected memory 110. In some embodiments, host processor(s) 102 may use expansion bus 116 to access results produced within secure execution zone 118 and/or provide data to be processed within secure execution zone 118.

Host-connected memory 104 and/or device-connected memory 110 may represent any type or form of memory capable of storing cacheable data. Examples of host-connected memory 104 and/or device-connected memory 110 include, without limitation, Dynamic Randomly Addressable Memory (DRAM), Static Randomly Addressable Memory (SRAM), High Bandwidth Memory (HBM), cache memory, volatile memory, non-volatile memory (e.g., Flash memory), or any other suitable form of computer memory. Memory bus 106 and/or memory bus 112 may represent any internal memory bus suitable for interfacing with host-connected memory 104 and/or device-connected memory 110. Examples of memory bus 106 and/or memory bus 112 include, without limitation, Double Data Rate (DDR) buses (e.g., Low Power DDR buses), Serial ATA (SATA) buses, Serial Attached SCSI (SAS) buses, High Bandwidth Memory (HBM) buses, Peripheral Component Interconnect Express (PCIe) buses, and the like.

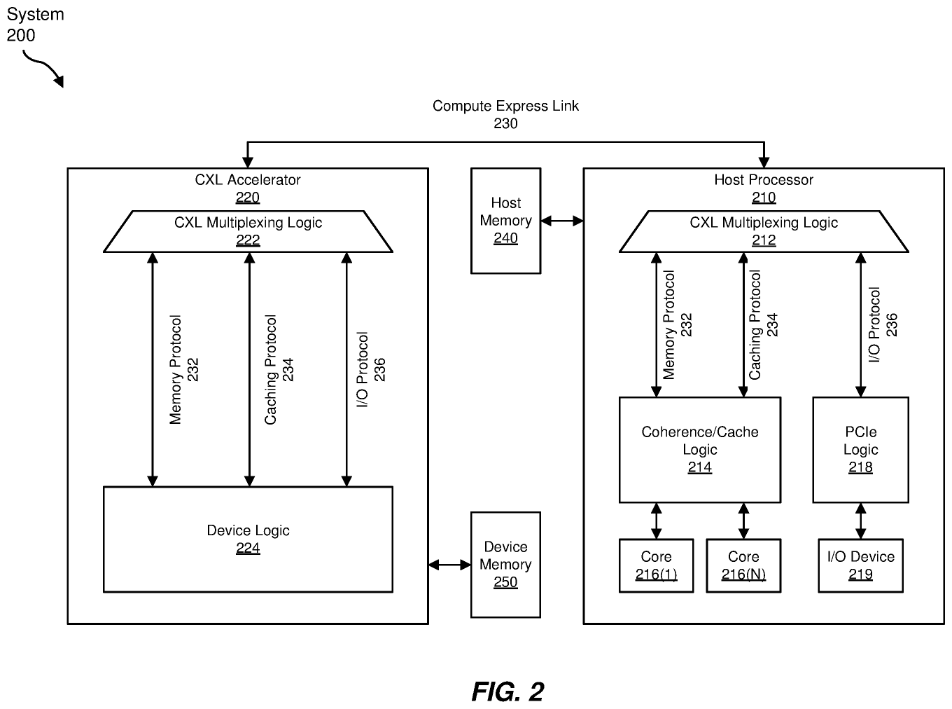

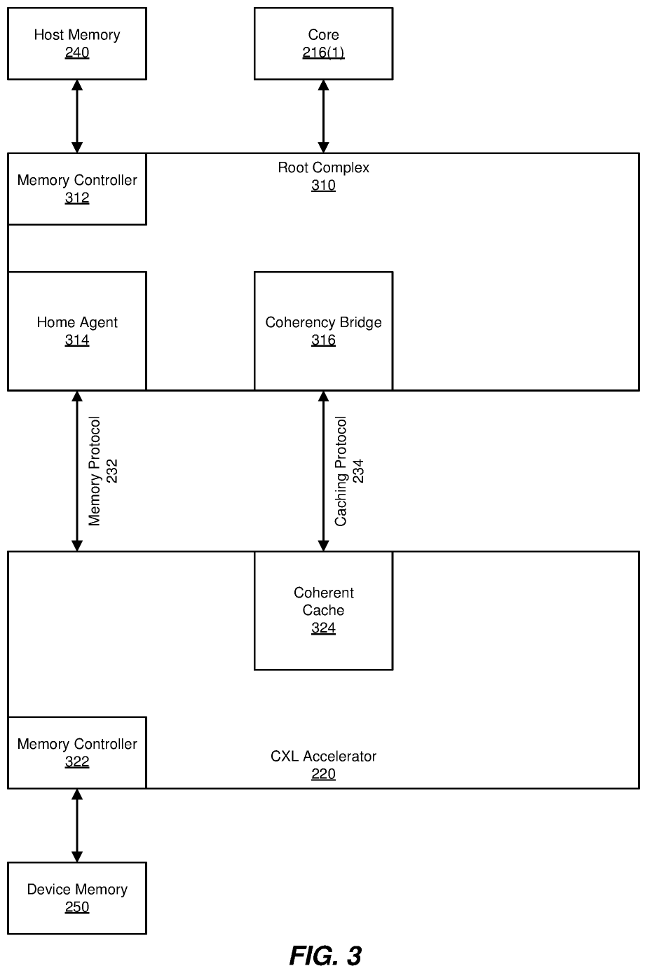

Expansion bus 116 may represent any high-bandwidth and/or low-latency chip-to-chip interconnect, external bus, or expansion bus. In some embodiments, expansion bus 116 may provide connectivity (e.g., I/O, coherence, and/or memory semantics) between host processor(s) 102 and external devices or packages such as caching devices, workload accelerators (e.g., Graphics Processing Unit (GPU) devices, Field-Programmable Gate Array (FPGA) devices, Application-Specific Integrated Circuit (ASIC) devices, machine learning accelerators, tensor and vector processor units, etc.), memory expanders, and memory buffers. In some embodiments, expansion bus 116 may include a standardized interconnect (e.g., a Peripheral Component Interconnect Express (PCIe) bus), a proprietary interconnect, or some combination thereof. In at least one embodiment, expansion bus 116 may include a Compute eXpress Link (CXL) interconnect such as those illustrated in FIGS. 2 and 3.

Example system 100 in FIG. 1 may be implemented in a variety of ways. For example, all or a portion of example system 100 may represent portions of an example system 200 in FIG. 2. As shown in FIG. 2, system 200 may include a host processor 210 connected to a CXL accelerator 220 via a compute express link 230. In some embodiments, host processor 210 may be directly connected to a host memory 240 via an internal memory bus, and CXL accelerator 220 may be directly connected to a device memory 250 via an internal memory bus. In this example, the internal components of host processor 210 may communicate over compute express link 230 with the internal components of CXL accelerator 240 using one or more CXL protocols (e.g., a memory protocol 232, a caching protocol 234, and/or an I/O protocol 236) that are multiplexed by multiplexing logic 212 and 222.

As shown in FIG. 2, host processor 210 may include one or more processing core(s) 216 that are capable of accessing and caching data stored to host memory 240 and device memory 250 via coherence/cache logic 214. Host processor 210 may also include an I/O device 219 that is capable of communication over compute express link 230 via PCIe logic 218. As shown in FIG. 3, in some embodiments, host processor 210 may include a root complex 310 (e.g., a PCIe compatible root complex) that connects one or more of cores 216 to host memory 240 and device memory 250. In this example, root complex 310 may include a memory controller 312 for managing read and write operations to host memory 240, a home agent 314 for performing translations between physical, channel, and/or system memory addresses, and a coherency bridge 316 for resolving system wide coherency for a given host address.

As shown in FIG. 2, CXL accelerator 220 may include device logic 224 for performing memory and CXL protocol tasks. In some embodiments, device logic 224 may include one or more secure execution zones and a memory controller 322 that manages read and write operations to device memory 250 (e.g., as shown in FIG. 3). In at least one embodiment, CXL accelerator 220 may include a coherent cache 324 for caching host-managed data (e.g., data stored to host memory 240 or device memory 250).

FIG. 4 illustrates an exemplary coherent memory space 410 having host addresses 412(1)-(Z) that have been mapped to (1) physical memory locations of host physical memory 104 and (2) physical memory locations of device physical memory 110. As shown, a memory range 413 of coherent memory space 410 may be mapped to memory locations 419(1)-(N) of host physical memory 104, a memory range 415 of coherent memory space 410 may be mapped to memory locations 422(1)-(N) of device physical memory 110 (e.g., memory region 522 in FIG. 5), and a memory range 417 of coherent memory space 410 may be mapped to memory locations 422(Z-Y)-(Z) of device physical memory 110 (e.g., memory region 524 in FIG. 5). In this example, host processors or accelerators that share access to coherent memory space 410 may read or write data to host physical memory 104 by accessing the host addresses in memory range 413. Similarly, host processors or accelerators that share access to coherent memory space 410 may read or write data to device physical memory 110 by accessing the host addresses in either of memory ranges 415 or 417. In some embodiments, host processors or accelerators that share access to coherent memory space 410 may use host addresses of coherent memory space 410 to reference and/or access the outputs of the secure execution zones disclosed herein.

As described above, accelerator 108 may include one or more secure execution zones for secretly executing sensitive applications and/or secretly processing sensitive data within heterogeneous systems. FIG. 5 is an illustration of an exemplary configuration of accelerator 108 having a single secure execution zone 118. Secure execution zone 118 may include one or more processors (e.g., a processor 500), one or more volatile memories (e.g., a volatile memory 502), and/or one or more non-volatile memories (e.g., a read only memory 504). In some embodiments, read only memory 504 may store some or all of sensitive application 120 (e.g., as sensitive code 508 and/or sensitive data 510). Additionally or alternatively, volatile memory 502 may store some or all of sensitive application 120 (e.g., as sensitive code 512 and/or sensitive data 514). In some embodiments, volatile memory 502 may store result 122 of executing sensitive application 120 within secure execution zone 118. Volatile memory 502 may represent any type or form of memory (e.g., Static Randomly Addressable Memory (SRAM)) that loses data when shut down or after losing power. As such, sensitive code 512 and sensitive data 514 may represent code and data that processor 500 loads from read only memory 504 on a restart of accelerator 108.

In some embodiments, volatile memory 502 and read-only memory 504 may be physically accessible to processors within secure execution zone 118 (e.g., processor 500) but physically inaccessible to processors outside of secure execution zone 118 (e.g., processor 114 and/or host processor(s) 102). In some embodiments, processor 500 may have sole access to memories 502 and 504. Additionally or alternatively, processor 500 may have (e.g., via one or more of securing elements 501, 503, and/or 505) sole access to some or all of the sensitive information stored to memories 502 and 504. In at least one embodiment, processor 114 may provide processor 500 and/or sensitive application 120 with access to a private region 518 of device-connected memory 110 to which sensitive application 120 may securely store (e.g., using encryption) data that will be secretly processed within secure execution zone 118.

In some embodiments, processor 500 may be configured to expose result 122 of processing sensitive application 120 to processor 114 and/or host processor(s) 102 using a hash map, a secure communication channel, a secure entry point (e.g., one or more registers accessible to both processor 500 and processor 114), and/or memory region 516 of device-connected memory 110. In some embodiments, processor 114 may be configured to relay results of executing sensitive application 120 from processor 500 to host processor(s) 102 via an expansion-bus interface 506. Additionally or alternatively, processor 114 may be configured to relay result 122 of executing application 120 from processor 500 to device-connected memory 110 (e.g., memory region 516) and later relay result 122 from device-connected memory 110 to host processor(s) 102.

Processor 500 may represent any physical processor configured to (1) ensure the confidentiality and/or integrity of sensitive application 120 and/or the data of sensitive application 120 before, during, and/or after execution of sensitive application 120 within secure execution zone 118 and also (2) expose result 122 of executing sensitive application 120 to processors located outside of secure execution zone 118 (e.g., host processor(s) 102 and/or processor 114). Processor 500 may ensure the confidentiality of secure code 508 and 512 and secure data 510 and 514 by preventing disclosure of secure code 508 and 512 and secure data 510 and 514 outside of secure execution zone 118. Processor 500 may ensure the integrity of secure code 508 and 512 and secure data 510 and 514 by preventing unauthorized modification and/or execution of secure code 508 and 512 and secure data 510 and 514. Examples of processor 500 include, without limitation, microprocessors, microcontrollers, Central Processing Units (CPUs), Digital signal processors (DSPs), Field-Programmable Gate Arrays (FPGAs), Application-Specific Integrated Circuits (ASICs), portions of one or more of the same, variations or combinations of one or more of the same, or any other suitable physical processor. In some embodiments, processor 500 may be Instruction Set Architecture (ISA) agnostic. Additionally or alternatively, processor 500 may be a physical processor based on a Reduced Instruction Set Computer (RISC) (e.g., a RISC-V processor).

In some embodiments, processor 500 may be uniquely configured to execute one or more sensitive applications. In one embodiment, processor 500 may represent a processor that incorporates and/or has access to specialized instructions and/or other specialized features (e.g., hash functions and/or cryptographic keys) for executing sensitive applications. In at least one embodiment, processor 500 may be specialized to ensure the confidentiality and/or integrity for only sensitive application 120. In other embodiments, processor 500 may represent a processor uniquely configured for one or more entities and specialized for executing third-party sensitive applications within the one or more entities' systems. Additionally or alternatively, processor 500 may represent a processor uniquely configured for one or more entities and specialized for executing the one or more entities' sensitive applications within third-party systems.

In addition to and/or as an alternative to being physically isolated from external processors, some or all of the components contained in secure execution zone 118 may include one or more securing elements (e.g., securing elements 501, 503, and 505) for ensuring the confidentiality and/or integrity of sensitive application 120 and/or its data before, during, and/or after execution and enabling results of executing sensitive application 120 to be exposed to processors located outside of secure execution zone 118. In some embodiments, the disclosed systems may use these securing elements to establish mutual trust. Additionally or alternatively, these securing elements may collectively provide a trusted execution environment for a sensitive application 120.

As shown in FIG. 6, securing elements 600 may include one or more authentication elements 602, one or more confidentiality elements 604, one or more identification elements 606, one or more integrity elements 608, one or more measurement elements 610, one or more authorization elements 612, one or more reporting elements 614, one or more verification elements 616, one or more hash maps 618, one or more hash-map instructions 620, one or more cryptographic keys 622, and/or one or more trusted platform modules 624. Some or all of securing elements 600 may be unique to a particular sensitive application and/or secure execution zone. In some embodiments, one or more of securing elements 600 may act as a hardware- or software-based root of trust for sensitive applications executing within secure execution zone 118 and/or any external applications that interact with the sensitive applications.

In some embodiments, authentication elements 602 may provide one or more authentication functions or services to sensitive application 120, processor 500, processor 114, and/or host processor(s) 102. For example, authentication elements 602 may include one or more authentication credentials that may be used for performing access control associated with result 122 and/or for authorizing access to result 122 for processor 114 and/or host processor(s) 102.

In some embodiments, confidentiality elements 604 may provide one or more confidentiality functions or services to sensitive application 120, processor 500, processor 114, and/or host processor(s) 102. For example, confidentiality element 604 may include secret keys and/or passwords for encrypting/decrypting data stored within secure execution zone 118. In at least one embodiment, processor 500 may include a secret key and/or password for decrypting data read from read only memory 504.

In some embodiments, identification elements 606 may provide one or more identification functions or services to sensitive application 120, processor 500, processor 114, and/or host processor(s) 102. For example, identification elements 606 may include one or more secret values (e.g., a symmetric key, an asymmetric private key, an identity key, an endorsement key etc.) for establishing the identity of sensitive application 120, processor 500, processor 114, and/or host processor(s) 102. In at least one embodiment, identification elements 606 may include a one-time programmable memory (e.g., a one-time programmable fuse) for storing keys and other cryptographic assets.

In some embodiments, integrity elements 608 may provide one or more integrity functions or services to sensitive application 120, processor 500, processor 114, and/or host processor(s) 102. For example, integrity elements 608 may include authorization values, public keys, and/or public key certificates for performing attestation operations.

In some embodiments, measurement elements 610 may provide one or more measurement functions or services to sensitive application 120, processor 500, processor 114, and/or host processor(s) 102. For example, measurement elements 610 may include cryptographic hash functions for calculating the hashes of code and/or data that may be used to perform integrity, verification, and/or trust-establishing operations.

In some embodiments, authorization elements 612 may provide one or more authorization functions or services to sensitive application 120, processor 500, processor 114, and/or host processor(s) 102. For example, authorization elements 612 may include authorization tokens that may be provided by processor 114 and/or host processor(s) 102 and used by processor 500 to perform access control measures associated with result 122.

In some embodiments, reporting elements 614 may provide one or more reporting functions or services to sensitive application 120, processor 500, processor 114, and/or host processor(s) 102. For example, reporting elements 614 may provide platform characteristics to sensitive application 120 that have been authenticated by processor 500.

In some embodiments, verification elements 616 may provide one or more verification functions or services to sensitive application 120, processor 500, processor 114, and/or host processor(s) 102. For example, verification elements 616 may enable sensitive application 120, processor 500, processor 114, and/or host processor(s) 102 to verify the integrity and/or authenticity of code, data, and/or public keys. In some embodiments, verification elements 616 may be used to perform verification checks on code read from read only memory 504 before the code is executed by processor 500. For example, verification elements 616 may include a read only memory bootloader stored to read only memory 504 that may be used to verify a signature of the next bootloader or software image in a chain of trust before passing control of processor 500 to the next bootloader or software image.

In some embodiments, hash maps 618 may map hashes (e.g., access tokens) to results of executing sensitive application 120 (e.g., result 122). In some embodiments, processor 500 may use hash maps 618 to expose the results outside of secure execution zone 118 and/or to control access to the results. In at least one embodiment, hash-map instructions 620 may include specialized instructions for accessing and/or initiating hash maps 618.

FIG. 7 is a flow diagram of an exemplary computer-implemented method 700 for executing a sensitive application within an accelerator-based secure execution zone and then providing a result to an external processor. The steps shown in FIG. 7 may be performed by any suitable computer-executable code and/or computing system, including the system(s) illustrated in FIGS. 1, 2, 3, and 5. In one example, each of the steps shown in FIG. 7 may represent an algorithm whose structure includes and/or is represented by multiple sub-steps, examples of which will be provided in greater detail below.

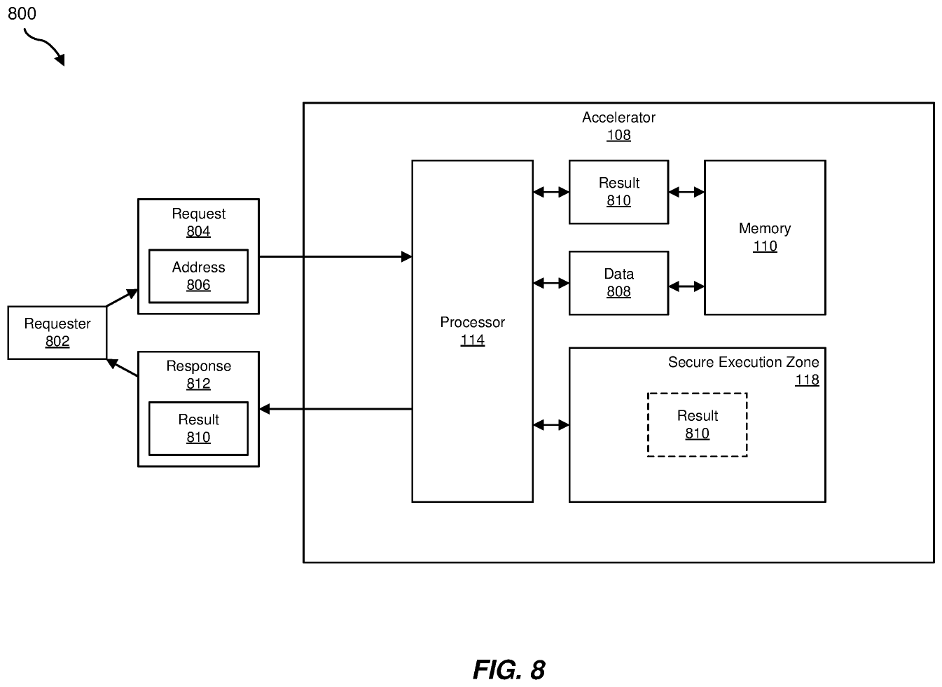

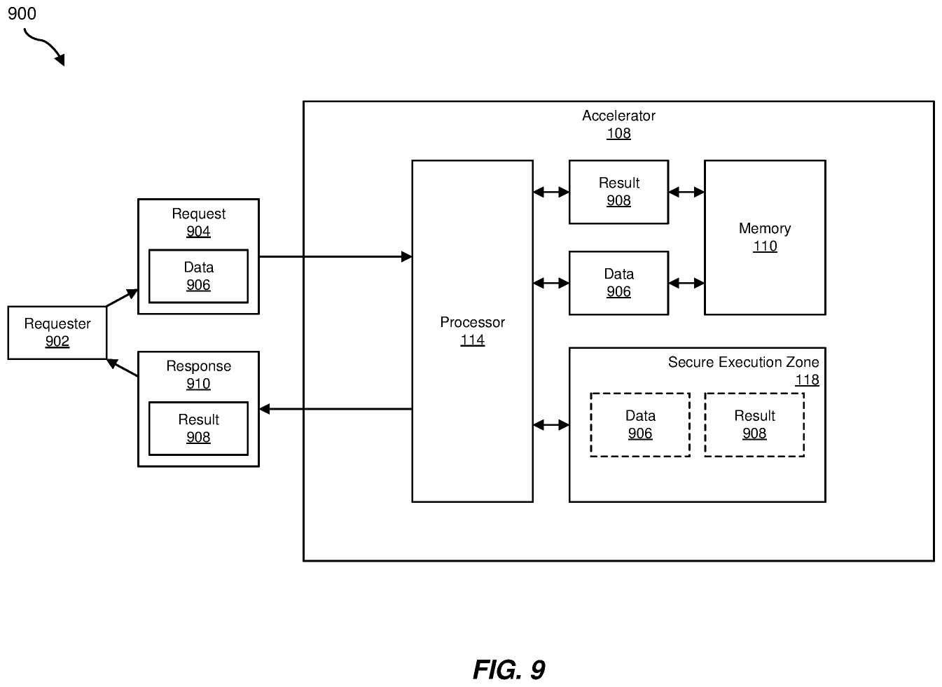

As illustrated in FIG. 7, at step 710 a first internal physical processor of one of the accelerators described herein may receive, from an external processor, a request to access a result of executing a sensitive application within a secure execution zone. For example, processor 114 may receive, from host processor 102 via expansion bus 116, a request to access result 122 of executing sensitive application 120 within secure execution zone 118. In some embodiments, a request to access a result of executing a sensitive application within a secure execution zone may include an address (e.g., a host address in coherent memory space 410) or another identifier (e.g., a hash) mapped to the result and/or to a location where the result can be accessed (e.g., as shown in FIG. 8). Additionally or alternatively, a request may include data to be processed by a sensitive application executing within a secure execution zone (e.g., as shown in FIG. 9). In such embodiments, processor 114 may relay the data to secure execution zone 118.

At step 720, a second internal physical processor within the secure execution zone may execute the sensitive application to generate the result. For example, processor 500 of secure execution zone 118 may execute sensitive code 508 and/or 512 within secure execution zone 118 to generate result 122. Then, at step 730, the second internal physical processor may make the result accessible outside of the secure execution zone. For example, processor 500 of secure execution zone 118 may make result 122 accessible to processor 114 and/or host processor(s) 102 located outside of secure execution zone 118. Finally, at step 740, the first internal physical processor may relay the result to the external processor. For example, processor 114 may relay result 122 to host processor(s) 102 via expansion bus 116.

FIG. 8 is a diagram of an exemplary data flow that may occur when the disclosed systems execute a sensitive application within an accelerator-based secure execution zone and then provide a result to an external requester. In this example, a requester 802 (e.g., a host processor, core, or thread) may transmit a request 804 to accelerator 108 for a result 810 of executing a secure application within secure execution zone 118. Result 810 may be a result of processing data 808 within secure execution zone 118. In this example, processor 114 may have facilitated access to data 808. As shown, request 804 may include an address 806 that may be used to access result 810. In some examples, processor 114 may use address 806 to request result 810 from processor 500. In other examples, address 806 may be mapped to a physical address within memory 110. In such examples, processor 500 may write result 810 to the physical address, and processor 114 may translate address 806 to identify the physical location before retrieving result 810 from memory 110. After retrieving result 810 from either secure execution zone 118 or memory 110, processor 114 may then relay result 810 to requester 802 via a response 812, as shown.

FIG. 9 is a diagram of an exemplary data flow that may occur when the disclosed systems process data received from an external processor using a sensitive application hosted within an accelerator-based secure execution zone and then provide a result to the external requester. In this example, a requester 902 (e.g., a host processor, core, or thread) may transmit a request 904 to accelerator 108 for a result 908 of processing data 906 within secure execution zone 118 using a secure application. In some embodiments, processor 114 may relay data 906 directly to processor 500 in secure execution zone 118. In other embodiments, processor 114 may store data 906 to memory 110 for later retrieval by processor 500 from secure execution zone 118. In such embodiments, processor 114 may facilitate access to data 906. In some embodiments, processor 500 may, after producing result 908 from data 906, provide result 908 to processor 114 for transmission to requester 902. In other embodiments, processor 500 may write result 908 to a physical address within memory 110 from which processor 114 may retrieve result 908. After retrieving result 908 from either secure execution zone 118 or memory 110, processor 114 may then relay result 908 to requester 902 via a response 910, as shown.

As explained above, embodiments of the present disclosure may protect the integrity and confidentiality of a sensitive application and its sensitive data while also enabling remote processors to access results of executing the sensitive application. Additionally, the disclosed accelerator-based secure execution zones may enable a third party's sensitive application to be executed within a partner's system in a way that prevents the partner from discovering how the sensitive application operates, which may enable partners to share intellectual property, trade secrets, proprietary algorithms, machine-learning models, and the like.

### EXAMPLE EMBODIMENTS

Example 1: An accelerator including (1) an expansion-bus interface, (2) one or more internal physical processors adapted to communicate with an external processor via the expansion-bus interface, and (3) a secure execution zone having (a) at least one additional internal physical processor adapted to execute a sensitive application within the secure execution zone and make a result of executing the sensitive application accessible to the external processor via the expansion-bus interface and (b) physical memory storing the sensitive application. The physical memory may be accessible to the additional internal physical processor and inaccessible to the external processor and the one or more internal physical processors.

Example 2: The accelerator of Example 1, wherein (1) the physical memory is volatile memory, (2) the secure execution zone further includes read only memory, (3) the read only memory stores executable instructions of the sensitive application, and (4) the additional internal physical processor is further adapted to load the executable instructions of the sensitive application into the volatile memory as part of a secure boot procedure.

Example 3: The accelerator of any of Examples 1 and 2, wherein the read only memory further stores one or more securing elements necessary for making the result accessible to the external processor.

Example 4: The accelerator of any of Examples 1-3, wherein (1) the one or more securing elements include a hashing function for generating a hash map, and (2) the result is made accessible to the external processor via the hash map.

Example 5: The accelerator of any of Examples 1-4, wherein the additional internal physical processor includes at least one securing element, that is necessary for accessing the executable instructions of the sensitive application stored to the read only memory, that differs from elements of one or more of the external processor and the one or more internal physical processors.

Example 6: The accelerator of any of Examples 1-5, wherein the read only memory further includes a secure bootloader for loading the sensitive application from the read only memory into the volatile memory.

Example 7: The accelerator of any of Examples 1-6, wherein the additional internal physical processor is further adapted to act as a root of trust in a secure boot procedure.

Example 8: The accelerator of any of Examples 1-7, wherein the additional internal physical processor is further adapted to establish trust between the sensitive application and the additional internal physical processor.

Example 9: The accelerator of any of Examples 1-8, wherein the additional internal physical processor is further adapted to establish trust between the sensitive application and one or more of the external processor and the one or more internal physical processors.

Example 10: The accelerator of any of Examples 1-9, wherein the additional internal physical processor is further adapted to (1) receive, from the one or more internal physical processors via a secure communication channel, a request to access the result and (2) transmit, in response to the request, the result to the one or more internal physical processors over the secure communication channel.

Example 11: The accelerator of any of Examples 1-10, wherein the one or more internal physical processors are further adapted to (1) receive, from the external processor via the expansion-bus interface, a request to access the result and (2) transmit, in response to the request, the result to the external processor via the expansion-bus interface.

Example 12: The accelerator of any of Examples 1-11, wherein (1) the expansion-bus interface is adapted to connect to a cache-coherent interconnect, (2) the accelerator further includes additional physical memory accessible to the external processor via the cache-coherent interconnect, addresses of the additional physical memory being mapped to a coherent memory space of the external processor, (3) the additional internal physical processor is adapted to make the result of executing the sensitive application accessible to the external processor by writing the result to a physical address of the additional physical memory accessible to the external processor, and (4) the one or more internal physical processors are further adapted to (a) receive, via the cache-coherent interconnect, a request to access a host address of the coherent memory space corresponding to the physical address and (b) respond to the request by accessing the result from the physical address of the additional physical memory corresponding to the host address.

Example 13: The accelerator of any of Examples 1-12, wherein the additional internal physical processor is adapted to write the result to the physical address of the additional physical memory by transmitting, to the one or more internal physical processors, a request to write the result to the host address of the coherent memory space corresponding to the physical address.

Example 14: A computer-implemented method including (1) receiving, by a first internal physical processor of an accelerator from an external processor, a request to access a result of executing a sensitive application within a secure execution zone of the accelerator having a second internal physical processor and physical memory storing the sensitive application, (2) executing, by the second internal physical processor within the secure execution zone of the accelerator, the sensitive application from the physical memory to generate the result, (3) making, by the second internal physical processor, the result accessible outside of the secure execution zone, and (4) relaying, by the first internal physical processor, the result to the external processor. The physical memory may be accessible to the second internal physical processor and inaccessible to the first internal physical processor and the external processor.

Example 15: A storage accelerator including (1) a device-attached physical memory accessible to an external host processor via a cache-coherent interconnect, wherein addresses of the device-attached physical memory are mapped to a coherent memory space of the external host processor, (2) one or more internal physical processors adapted to (a) receive, via the cache-coherent interconnect, a request to access a host address of the coherent memory space and (b) respond to the request by accessing a physical address of the device-attached physical memory corresponding to the host address, and (3) a secure execution zone having at least one additional internal physical processor adapted to execute a sensitive application within the secure execution zone and make a result of executing the sensitive application within the secure execution zone accessible to the external host processor via the cache-coherent interconnect.

Example 16: The storage accelerator of Example 15, wherein (1) the one or more internal physical processors are further adapted to provision a private region of the coherent memory space of the external host processor for use by the additional internal physical processor, and (2) the additional internal physical processor is further adapted to provide the sensitive application with access to the private region of the coherent memory space of the external host processor.

Example 17: The storage accelerator of any of Examples 15 and 16, wherein the secure execution zone further includes additional physical memory storing the sensitive application and sensitive data necessary in producing the result, the additional physical memory being accessible to the additional internal physical processor and inaccessible to the external host processor and the one or more internal physical processors.

Example 18: The storage accelerator of any of Examples 15-17, wherein (1) the additional physical memory is volatile memory, (2) the secure execution zone further includes read only memory, (3) the read only memory stores executable instructions of the sensitive application, and (4) the additional internal physical processor is further adapted to load the executable instructions of the sensitive application into the volatile memory as part of a secure boot procedure.

Example 19: The storage accelerator of any of Examples 15-18, wherein the read only memory further stores one or more securing elements necessary for making the result accessible to the external processor.

Example 20: The storage accelerator of any of Examples 15-19, wherein the one or more securing elements include a hashing function for generating a hash map, and the result is made accessible to the external processor by the hash map.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read only memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed over a cache-coherent interconnect, secretly process the data within an accelerator-based secure execution zone, output a result of the processing to device-connected memory, and use the result of the processing to respond to future read requests for the result. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of a device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An accelerator comprising:
an expansion-bus interface;
one or more internal physical processors adapted to communicate with an external processor via the expansion-bus interface; and
a secure execution zone comprising:
at least one additional internal physical processor adapted to:
execute a sensitive application within the secure execution zone; and
make a result of executing the sensitive application accessible to the external processor via the expansion-bus interface; and
physical memory comprising the sensitive application, the physical memory being accessible to the additional internal physical processor and inaccessible to the external processor and the one or more internal physical processors.

2. The accelerator of claim 1, wherein:
the physical memory is volatile memory;
the secure execution zone further comprises read only memory;
the read only memory stores executable instructions of the sensitive application; and
the additional internal physical processor is further adapted to load the executable instructions of the sensitive application into the volatile memory as part of a secure boot procedure.

3. The accelerator of claim 2, wherein the read only memory further stores one or more securing elements necessary for making the result accessible to the external processor.

4. The accelerator of claim 3, wherein:
the one or more securing elements comprise a hashing function for generating a hash map; and
the result is made accessible to the external processor via the hash map.

5. The accelerator of claim 2, wherein the additional internal physical processor comprises at least one securing element, necessary for accessing the executable instructions of the sensitive application stored to the read only memory, that differs from elements of one or more of the external processor and the one or more internal physical processors.

6. The accelerator of claim 2, wherein the read only memory further comprises a secure bootloader for loading the sensitive application from the read only memory into the volatile memory.

7. The accelerator of claim 1, wherein the additional internal physical processor is further adapted to act as a root of trust in a secure boot procedure.

8. The accelerator of claim 1, wherein the additional internal physical processor is further adapted to establish trust between the sensitive application and the additional internal physical processor.

9. The accelerator of claim 1, wherein the additional internal physical processor is further adapted to establish trust between the sensitive application and one or more of:
the external processor; and
the one or more internal physical processors.

10. The accelerator of claim 1, wherein the additional internal physical processor is further adapted to:
receive, from the one or more internal physical processors via a secure communication channel, a request to access the result; and
transmit, in response to the request, the result to the one or more internal physical processors over the secure communication channel.

11. The accelerator of claim 10, wherein the one or more internal physical processors are further adapted to:
receive, from the external processor via the expansion-bus interface, a request to access the result; and
transmit, in response to the request, the result to the external processor via the expansion-bus interface.

12. The accelerator of claim 1, wherein:
the expansion-bus interface is adapted to connect to a cache-coherent interconnect;
the accelerator further comprises additional physical memory accessible to the external processor via the cache-coherent interconnect, wherein addresses of the additional physical memory are mapped to a coherent memory space of the external processor;
the additional internal physical processor is adapted to make the result of executing the sensitive application accessible to the external processor by writing the result to a physical address of the additional physical memory accessible to the external processor;
the one or more internal physical processors are further adapted to:
receive, via the cache-coherent interconnect, a request to access a host address of the coherent memory space corresponding to the physical address; and
respond to the request by accessing the result from the physical address of the additional physical memory corresponding to the host address.

13. The accelerator of claim 12, wherein the additional internal physical processor is adapted to write the result to the physical address of the additional physical memory by transmitting, to the one or more internal physical processors, a request to write the result to the host address of the coherent memory space corresponding to the physical address.

14. A computer-implemented method comprising:
receiving, by a first internal physical processor of an accelerator from an external processor, a request to access a result of executing a sensitive application within a secure execution zone of the accelerator, the secure execution zone comprising:
a second internal physical processor; and
physical memory storing the sensitive application, the physical memory being accessible to the second internal physical processor and inaccessible to the first internal physical processor and the external processor;
executing, by the second internal physical processor within the secure execution zone of the accelerator, the sensitive application from the physical memory to generate the result;
making, by the second internal physical processor, the result accessible outside of the secure execution zone; and
relaying, by the first internal physical processor, the result to the external processor.

15. A storage accelerator comprising:
a device-attached physical memory accessible to an external host processor via a cache-coherent interconnect, wherein addresses of the device-attached physical memory are mapped to a coherent memory space of the external host processor;
one or more internal physical processors adapted to:
receive, via the cache-coherent interconnect, a request to access a host address of the coherent memory space; and
respond to the request by accessing a physical address of the device-attached physical memory corresponding to the host address; and
a secure execution zone comprising:
at least one additional internal physical processor adapted to:
execute a sensitive application within the secure execution zone; and
make a result of executing the sensitive application within the secure execution zone accessible to the external host processor via the cache-coherent interconnect.

16. The storage accelerator of claim 15, wherein:
the one or more internal physical processors are further adapted to provision a private region of the coherent memory space of the external host processor for use by the additional internal physical processor; and
the additional internal physical processor is further adapted to provide the sensitive application with access to the private region of the coherent memory space of the external host processor.

17. The storage accelerator of claim 15, wherein the secure execution zone further comprises additional physical memory storing the sensitive application and sensitive data necessary in producing the result, the additional physical memory being accessible to the additional internal physical processor and inaccessible to the external host processor and the one or more internal physical processors.

18. The storage accelerator of claim 17, wherein:
the additional physical memory is volatile memory;
the secure execution zone further comprises read only memory;
the read only memory stores executable instructions of the sensitive application; and
the additional internal physical processor is further adapted to load the executable instructions of the sensitive application into the volatile memory as part of a secure boot procedure.

19. The storage accelerator of claim 18, wherein the read only memory further stores one or more securing elements necessary for making the result accessible to the external processor.

20. The storage accelerator of claim 19, wherein:
the one or more securing elements comprise a hashing function for generating a hash map; and
the result is made accessible to the external processor by the hash map.
